(19) United States
(12) Patent Application Publication
(10) Pub. No.: US 2026/0102799 A1
(43) Pub. Date: Apr. 16, 2026

(54) SYSTEM AND APPARATUS FOR ALKALINE HYDROLYSIS, AND METHOD OF OPERATING SAME AND PERFORMING ALKALINE HYDROLYSIS

(71) Applicant: Jacob D'ARGY, Reynoldsville, PA (US)

(72) Inventor: Jacob D'ARGY, Reynoldsville, PA (US)

(21) Appl. No.: 19/115,240

(22) PCT Filed: Sep. 28, 2023
(86) PCT No.: PCT/US2023/075307

§ 371 Date: Mar. 25, 2025

Related U.S. Application Data
(60) Provisional application No. 63/377,621, filed on Sep. 29, 2022.
(60) Provisional application No. 63/377,614, filed on Sep. 29, 2022.
(60) Provisional application No. 63/379,329, filed on Oct. 13, 2022.
(60) Provisional application No. 63/380,442, filed on Oct. 21, 2022.

(51) Int. Cl. B09B 3/70; A62D 3/35; A62D 3/36

(52) U.S. Cl. CPC B09B 3/70; A62D 3/35; A62D 3/36

(57) ABSTRACT

A machine configured to perform alkaline hydrolysis can include a body having a base wall and a sidewall extending upwardly therefrom. The body can define a cavity configured to receive liquid and a corpse. The machine can further include a lid pivotally attached to the body about a hinge. The hinge can be attached to the lid and the sidewall of the body. The lid can be pivotably with respect to the body between a closed position and an open position. A basket can be configured to receive a corpse. The basket can be positionable within the body. A support structure can be configured to maintain the body, the lid, and the basket above a ground surface when the support structure is in an assembled configuration. The support structure can include a plurality of segments that are removably attachable to each other and the body.

### CROSS-REFERENCE TO RELATED APPLICATIONS

The present application claims priority to U.S. Provisional Application No. 63/380,442 filed Oct. 21, 2022, U.S. Provisional Application No. 63/379,329, filed Oct. 13, 2022, and U.S. Provisional Application Nos. 63/377,621 and 63/377,614, each filed Sep. 29, 2022, the disclosure of each of which is hereby incorporated by reference in their entirety.

### FIELD

The presently disclosed technology relates generally to decomposition processes. More specifically, in one embodiment, the presently disclosed technology is directed to making the process of alkaline hydrolysis easier and/or more efficient.

### BACKGROUND AND DESCRIPTION OF RELATED ART

Alkaline hydrolysis is well known. See, e.g., U.S. Pat. Nos. 8,235,319 and 9,018,433, which are hereby incorporated by reference.

Alkaline hydrolysis uses water, alkaline chemicals, heat, and sometimes pressure and agitation, to accelerate natural decomposition of remains or a corpse, leaving bone fragments and high-pH liquid. The decomposition that occurs relatively quickly in alkaline hydrolysis is the same as that which occurs relatively slowly during burial, meaning that over a long period of time, when the corpse decomposes naturally. In an alkaline state, the pH level elevates and the body (e.g., human or animal) decomposes under normal circumstances. The effluent is sterile, and contains salts, sugars, amino acids, and peptides. There is no tissue and no DNA left after the process completes. This effluent can be discharged with all other wastewater.

One benefit of alkaline hydrolysis is that the process is considered more environmentally friendly than cremation and traditional burial, at least because there are no emissions from alkaline hydrolysis. Another benefit is that alkaline hydrolysis gives families additional options upon the death of a loved one. Alkaline hydrolysis does not use fire, which can injure the operator, and can be a less expensive alternative to cremation and traditional burial.

### SUMMARY

Despite the numerous benefits of the prior art alkaline hydrolysis processes and machines, there is a need for an improved system, machine, and process that more quickly, easily, and efficiently allows conducts or completes alkaline hydrolysis. For example, prior art alkaline hydrolysis machines are often large, heavy, and difficult to move. This can contribute to making alkaline hydrolysis expensive and/or difficult to administer. These burdens of weight, size, and movability can severely limit the available spaces in which the prior art machines can be erected for use by the operator, and may also require that significant changes or costly renovations be made to the area in which the operator does have available for usage. It could also mean that prior art machines are simply unable to be used at all for many operators simply due to the above-mentioned burdens.

Further, certain prior art alkaline hydrolysis machines require that the body to be decomposed is lifted up over a sidewall of the machine, into an interior of the machine, and then lowered into the machine. There can be several drawbacks to this prior art approach, including that it can be difficult to accomplish, and often requires two or more individuals to complete. Other prior art alkaline hydrolysis machines include awkward or challenging ways to place the body to be decomposed into the interior of the machine.

The presently disclosed technology overcomes the above and other drawbacks of the prior art.

In one embodiment, the presently disclosed technology is directed to a machine configured to perform alkaline hydrolysis that can include a body having a base wall and a sidewall extending upwardly therefrom. The body can define a cavity configured to receive liquid and a body of a human being. A lid can be pivotally attached to the body about a hinge. The hinge can be attached to the lid and the sidewall of the body. The lid can be pivotably with respect to the body between a closed position and an open position. A basket can be configured to receive a human corpse. The basket can be positionable within the body. A support structure can be configured to maintain the body, the lid, and the basket above a ground surface when the support structure is in an assembled configuration. The support structure can include a plurality of segments that are removably attachable to each other and the body.

In one embodiment, the presently disclosed technology is directed to a machine configured to perform alkaline hydrolysis. The machine can include a body having a base wall and a sidewall extending upwardly therefrom. The body can define a cavity configured to receive liquid and a body of a human being. A lid can be pivotally attached to the body about at least one hinge. The at least one hinge can be attached to the lid and the sidewall of the body. The lid can be pivotably with respect to the body between a closed position and an open position. A basket can be movable into and at least partially out of the body when the lid is in the open position.

In another embodiment, the presently disclosed technology is directed to a method of performing alkaline hydrolysis that can include receiving a lid prompt on a screen, which is operatively connected to a machine configured to perform alkaline hydrolysis, to open a lid of the machine. The method can further include acknowledging or accepting the lid prompt, thereby allowing the lid of the machine to pivot from a closed position to an open position with respect to a body of the machine. The method can include receiving a basket prompt on the screen to open or raise a basket from within the body. The method can include acknowledging or accepting the basket prompt, thereby allowing the basket to rise up at least partially out of the body. The method can include moving a corpse at least partially into the basket.

In another embodiment, the presently disclosed technology is directed to a method of performing alkaline hydrolysis on a corpse. The method can include loading a corpse into a basket of a machine configured to perform alkaline hydrolysis. The method can further include causing the basket to rotate with respect to a body of the machine so that the basket and the corpse are positioned entirely within the body.

### BRIEF DESCRIPTION OF THE DRAWINGS

The foregoing summary, as well as the following detailed description of the presently disclosed technology, will be better understood when read in conjunction with the appended drawings, wherein like numerals designate like elements throughout. For the purpose of illustrating the presently disclosed technology, there are shown in the drawings various illustrative embodiments. It should be understood, however, that the presently disclosed technology is not limited to the precise arrangements and instrumentalities shown.

In the drawings:

FIG. 1 is a perspective view of an alkaline hydrolysis machine of one embodiment of the presently disclosed technology from a first direction, wherein a lid of the machine is shown in a first or closed position;

FIG. 2 is another perspective view of the machine shown in FIG. 2 from an opposing second direction;

FIG. 3 is a partially exploded view of the machine shown in FIG. 1;

FIG. 4 is a side elevation view of the machine shown in FIG. 1;

FIG. 5 is a cross-sectional view of the machine shown in FIG. 1 taken along line A-A of FIG. 2;

FIG. 6 shows the machine of FIG. 1 with the lid in a second or open position, wherein the lid has been rotated or pivoted with respect to a body to expose a cavity;

FIG. 7 shows the machine of FIG. 1 with the lid in the open position, wherein a basket is shown rotated at exactly or approximately 15 degrees with respect to a top surface of the body and/or a ground surface;

FIG. 8 shows the machine of FIG. 1 with the lid in the open position, wherein a basket is shown rotated at exactly or approximately 40 degrees with respect to the top surface of the body and/or the ground surface;

FIG. 9 shows the machine of FIG. 1 in the open position, wherein a basket is shown rotated at exactly or approximately 40 degrees with respect to the top surface of the body and/or the ground surface;

FIG. 10 is a schematic diagram of a cabinet of the machine in accordance with one embodiment of the presently disclosed technology, wherein the cabinet is shown slightly spaced-apart from a body of the machine;

FIG. 11 is a perspective view of a portion of the machine shown in FIG. 1; and

FIG. 12 is a schematic diagram of a computing system of one embodiment of the present disclosure.

### DETAILED DESCRIPTION

While systems, devices and methods are described herein by way of examples and embodiments, those skilled in the art recognize that the presently disclosed technology is not limited to the embodiments or drawings described. Rather, the presently disclosed technology covers all modifications, equivalents and alternatives falling within the spirit and scope of the appended claims. Features of any one embodiment disclosed herein can be omitted or incorporated into another embodiment.

For the purpose of this application, the “consumer” is defined as the person or people that will be buying the unit, and not the people (e.g., cadavers or bodies) that will be processed through and/or in the unit. The identifying word “consumer” will be interchangeable with the identifying word of operator for the purpose of this explanation.

Any headings used herein are for organizational purposes only and are not meant to limit the scope of the description or the claims. As used herein, the words “may” and “can” arc used in a permissive sense (i.e., meaning having the potential to) rather than the mandatory sense (i.e., meaning must). Unless specifically set forth herein, the terms “a,” “an” and “the” are not limited to one element but instead should be read as meaning “at least one.” The terminology includes the words noted above, derivatives thereof and words of similar import.

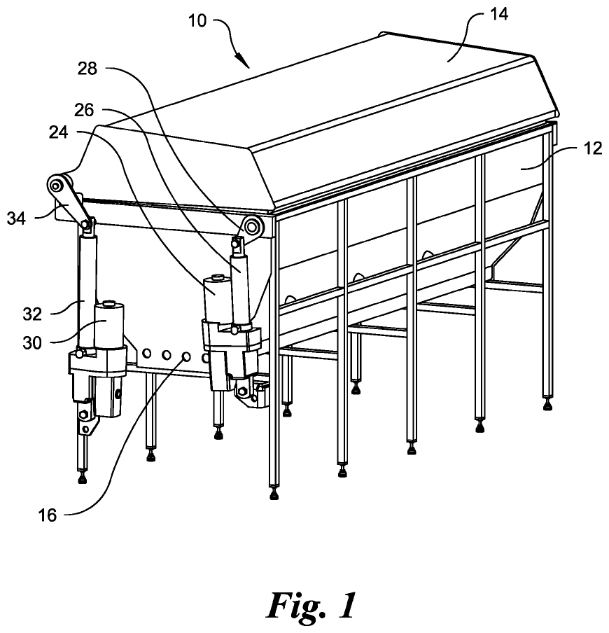

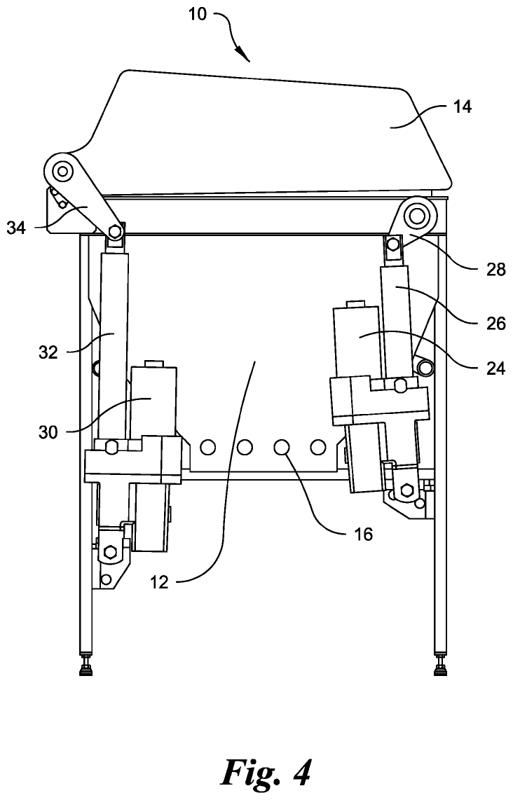

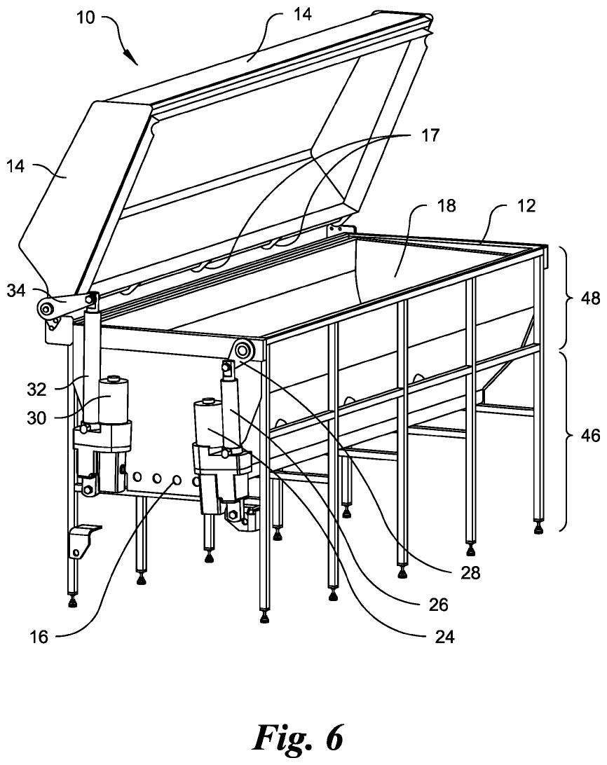

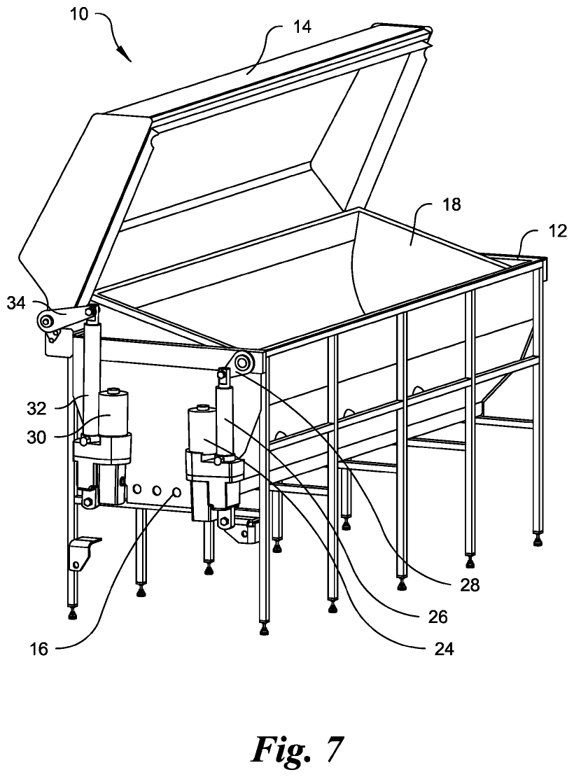

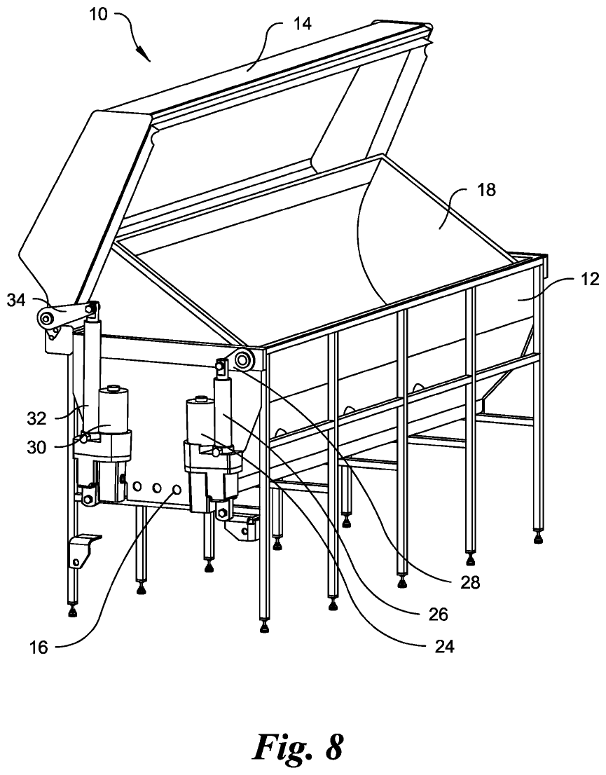

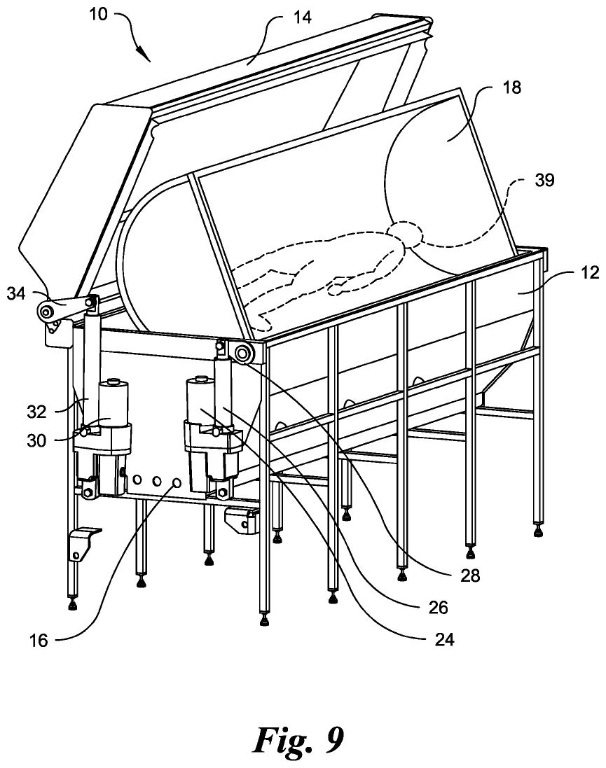

Referring now in detail to the figures, wherein like reference numerals refer to like parts throughout, FIGS. 1-12 show a machine, generally designated 10, of one embodiment of the present application that is configured to perform alkaline hydrolysis on a deceased individual 39 (shown schematically in FIG. 9), such as a deceased human being or corpse. The machine 10 can optionally include a tank or body 12, a lid 14 pivotally and/or removably attached to the tank 12 by one or more spaced-apart hinges 17 (see FIG. 6). The tank 12 can be rectilinear in form (e.g., having a length that is about or exactly twice a width), and/or include angled or slanted front and rear sidewalls.

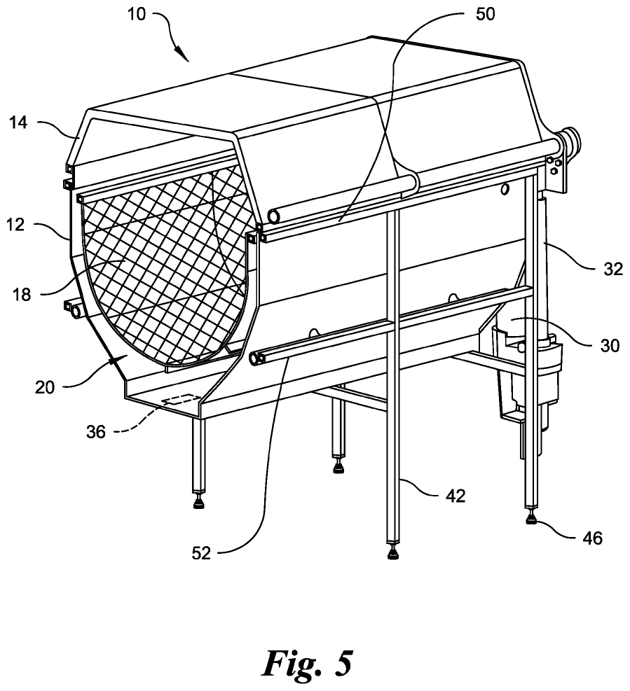

Optionally, the machine 10 can include a pivotable, rotatable, and/or removably basket or carrier 18 that is movable with respect to the tank 12 of the machine 10. The basket 18 can be configured to move into and/or at least partially out of a cavity 20 (see FIG. 5) of the tank 12 of the machine 10. In one optional embodiment, the lid 14 and the basket 18 pivot about axes that extend in parallel, even if spaced-apart by about or exactly the width of the tank 12. For example, the lid 14 can be configured to pivot at or near a rear longitudinal edge of the tank 12, and the basket 18 can be configured to pivot at or near a front longitudinal edge of the tank 12.

The basket 18 can be sized, shaped, and/or configured to at least partially or completely receive the remains of a human 39 (e.g., a cadaver), for example, or even an animal. For example, the basket 18 can be generally in the form of a cylinder cut along its longitudinal axis, such that part of the basket 18 forms a curved, concave, or arcuate surface that has a radius of curvature at least slightly smaller than any radius of curvature of the bottom of the tank 12. Similar to the tank 12 thought at least slightly smaller, a length of the basket 18 can be about or exactly twice a width of the basket 18.

The basket 18 can be formed of a solid or non-porous material, or at least a portion or the entirety of the basket 18 can be porous or perforated (e.g., can include a plurality of spaced-apart holes) (see, e.g., FIG. 5) to allow liquid or chemicals, but not necessarily any portion (e.g., bones) of the corpse 39, to pass therethrough. For example, the basket 18 can be formed of a chain-link material or a rigid mesh material. Such a porous or perforated configuration of the basket 18 allows liquid and/or chemicals to freely interact with the corpse while simultaneously containing most if not all of the sizeable or not-yet-liquified remains from the corpse within the basket 18.

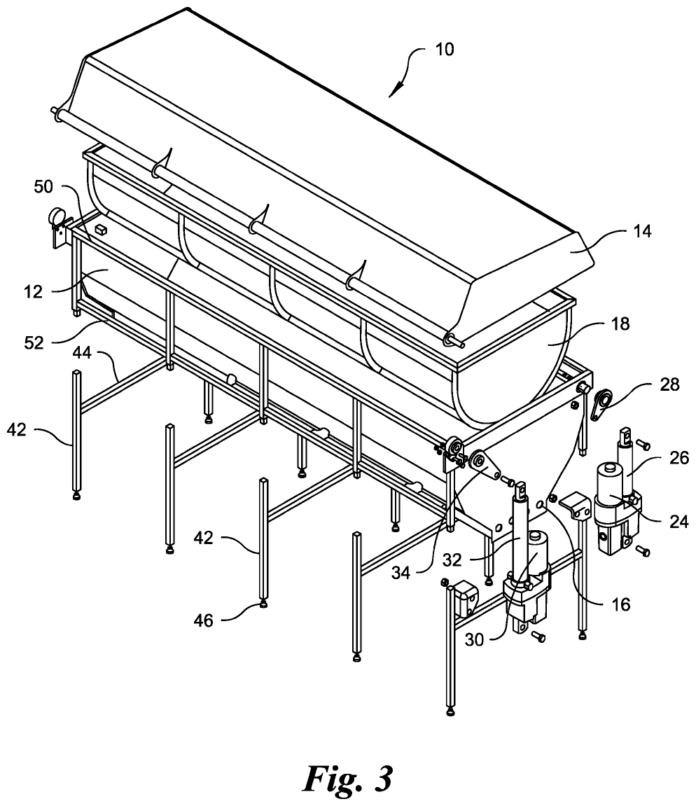

In one optional embodiment, the basket 18 is configured to pivot approximately or exactly 90 degrees from its resting position within the cavity 20 of the tank 12 (e.g., see FIGS. 3, 5 and/or 6) to a vertical or almost vertical position out of the tank 12 (e.g., see FIG. 9). This movement is depicted at certain points in FIGS. 6-9, which are intended to convey the range of motion of the basket 18 with respect to the tank 12 in one optional embodiment and not simply to show only discrete positions of the basket 18 with respect to the tank 12.

The pivoting of the basket 18 is key in one embodiment of the presently disclosed technology to the ease of use of the machine 10 and this particular part of the process, and is fundamentally different from any prior art machine. In particular, such movement of the basket 18 allows for a flat or mostly flat surface (e.g., a gurney or cot) to be used to move the corpse 39 to the edge of the machine 10 or the tank 12, and then easily and/or gently move or slide the corpse 39 into the raised or rotated basket 18. These unique design aspects allow the decedent remains to be easily transferred from the cot or other apparatus into the machine 10, especially if using a slide board, from the cot into the basket 18. For example, the cot or other carrying device can simply be rolled up next to the machine 1 in preparation for loading the cadaver 39 into the machine 1. Optionally, in one embodiment, once the remains are successfully loaded into the raised basket 18, the slide board, cot, or gurney, for example, is removed and moved away from the machine 10. In most cases remains can be loaded in the machine 1 requiring only one person to do so, and this task can be safely accomplished with relatively little effort. The basket 18 can then be rotated or pivoted back into the cavity 20 of the tank 12.

Optionally, as shown in FIGS. 1, 3, 4, and 6-9, at least one basket motor 24 and/or at least one basket piston 26 can optionally be used to facilitate movement of the basket 18 with respect to the tank 12. The basket motor 24 can be any of a variety of known motors, such as an electric motor, capable of providing sufficient power to accomplish the functionality described herein. In operation, basket motor 24 can actuate the basket piston 26, which in turn can rotate a basket link or lever 28 or other mechanical or electronic mechanism. In such an embodiment, as the basket lever 28 is rotated, the basket 18 can rotate with respect to the tank 12 (e.g., at the same degree and/or pace) as described above. The above-described configuration and elements can be duplicated on the opposing side of the machine 10, if desired, or can be located on only one side of the tank 12.

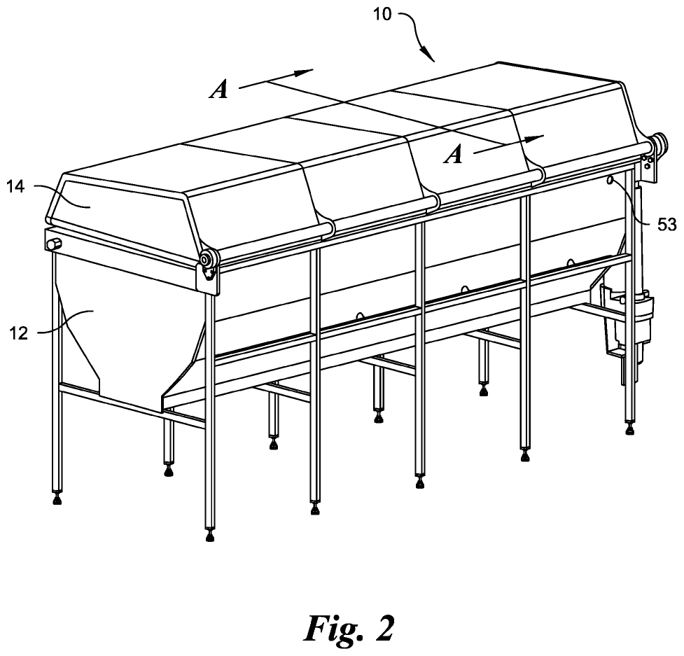

Optionally, as shown in FIGS. 1-9, at least one lid motor 30 and/or at least one lid piston 32 can optionally be used to facilitate movement of the lid 14 with respect to the tank 12 from a closed position (see FIG. 1) to an open position (see FIGS. 2-5). The lid motor 30 can be any of a variety of known motors, such as an electric motor, capable of providing sufficient power to accomplish the functionality described herein. In operation, the lid motor 30 can actuate the lid piston 32, which in turn can rotate a lid link or lever 34 or other mechanical or electronic mechanism. As the lid lever 34 is rotated, the lid 14 can be rotated with respect to the tank 12. The above-described configuration and elements can be duplicated on the opposing side of the machine 10, if desired, or can be located on only one side of the tank 12.

In one optional embodiment, the machine 10 of the presently disclosed technology is completely, substantially, or at least partially modular. More specifically, at least certain parts or components of the machine 10 are able to be made lighter in weight, easier to handle, and/or configured to be quickly and/or easily assembled and/or disassembled on-site (e.g., at a funeral home or crematory), unlike the bulky, heavy prior art machines. Also, in one embodiment, because of the design's relatively compact and/or small dimensions, the machine 10 requires less operating square footage than any other machine available. This is beneficial because the machine 10 allows alkaline hydrolysis to be administered in more locations. A modular machine such as the presently disclosed allows it or pieces thereof to be moved through small doors, up and down stairs, around tight corners, into more confined rooms, etc.

Optionally, as shown in FIGS. 3, 5, and 6, the machine 1 includes a first or lower frame, generally designated 40, configured to support at least the tank 12, the lid 14, and the basket 18 above the ground surface. The lower frame 40 can include a plurality of spaced-apart and removable legs 42. Each pair of legs 42 on opposing sides of the machine 1 can be connected by a crossbar 44. A lower end of each leg 42 can optionally include an adjustable foot 46, which can allow the operator to stabilize the machine 1 on an unlevel surface. An upper end of each leg 42 can removably engage or receive a lower end of a second or upper frame, generally designated 48. The upper frame 48 can include a plurality of projections 50 that extend at least slightly downwardly from the second frame 48 to engage or connect to the upper end of one of the legs 42. The upper frame 48 can be configured to surround and/or support the tank 12. Optionally, the upper frame 48 can include an upper axial support bar 50 spaced-apart from a lower axial support bar 52 on each side of the tank 12. The components of the lower and upper frames 40, 48 can be removably attachable with each other and/or among themselves, which allows the machine 1 to be easily and quickly assembled and disassembled.

In one embodiment, if water lines, drain lines, and the appropriate amount of electricity (e.g., no more than 160 Amps) to the purposed area in which the machine 1 is wanted by the consumer/operator, the machine 1 can be placed and/or used almost anywhere. In contrast, prior art machines require forklifts or other heavy machinery to move and place and are very limited to where they can be set up. The prior art typically involves retrofitting a building or constructing a purpose-built area for these competing machines.

In one embodiment of the presently disclosed technology, the tank 12 and optionally all parts associated with the machine 1 are stainless steel, which can be helpful to protect the machine against the corrosive and caustic nature of the chemicals used in the process of alkaline hydrolysis. The most commonly used chemical compound being potassium hydroxide, or KOH.

In one embodiment, the design of the presently disclosed technology eliminates the need for extra pieces of equipment to operate it. For example, certain prior art machines require that a scissor lift type piece of equipment be used to load and unload the remains, which, in most cases requires at least two people or a separate apparatus to clumsily load a body into, and place back into the machine. These larger pieces of extra equipment, for this purpose referring to the scissor lifts, require significant floor space to maneuver the device and are required to be charged as they operate on batteries. The very nature of the scissor lift type device adds the unneeded possibility of injury to the operators of prior art machines. These same lifts are almost always used when loading a corpse into a machine that cremates using fire.

The presently disclosed technology does not require these types of lift, which lowers cost and maintenance to the operator, while reducing the likelihood of injury to the operator. Cots and slide boards, for example, are generally readily available in most funeral homes as standard equipment that are used daily. Alternatively, cots and/or slide boards, for example, can be easily and readily purchased at a much lower cost if need be.

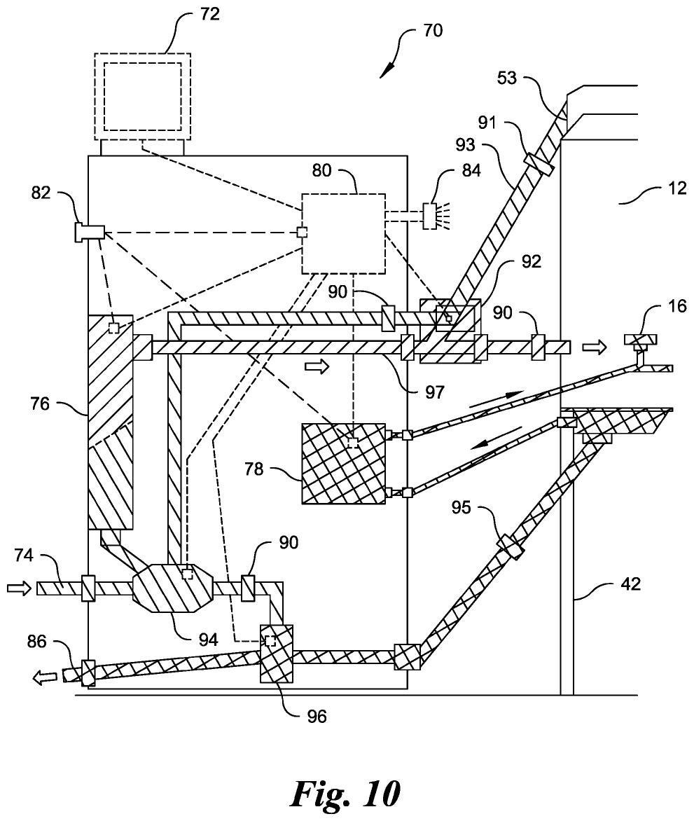

In one optional embodiment, the machine 1 can include a cabinet or attachment, generally designated 70 (shown schematically in FIG. 10), that can be located next to an exterior to the tank 12, perhaps supported on the ground surface or directly attached to a portion of the tank 12 or another part of the machine 1. In one embodiment, the cabinet 70 is in the form of a box that sits to the side of the tank 12, but can optionally be separated by a short open-to-the-air space, from the remainder of the machine 1 and/or the tank 12. Optionally, the cabinet 70 can include one or more components that allow an operator to control operation of the machine 1. A power adapter or connector 82 can be used to electrically connect the cabinet 70 with the electrical power source of the building.

In operation of one operational embodiment, referring to FIG. 10, when the cot or other supporting device is in place next to the machine 1, and the operator is ready to begin the process of using the machine 1, the operator can approach a control unit 72, such as a display or digital screen, located on the side of the cabinet 70 and indicate that they are ready to use the machine 1. The operator can then turn on the machine 1 through the control unit 72, and the process can begin.

Optionally, when the process is started, the operator will be prompted on the display 72 to perform at least one or many functions. Optionally, one or more questions that the display 72 asks or shows are purposeful in redundancy to help to ensure that all steps are properly followed to complete the process safely and efficiently. When caring for the remains of a deceased person 39, purposefully slowing down the loading process is built into the machine 1, which forces safety aspects onto the operator that they would simply have to follow.

Optionally, the operator will be asked if they are ready to have the lid 14 opened. When acknowledged or accepted, possibly through contact of the display 72 by the operator, the lid 14 will begin to open automatically by way of one or more mechanical actuators, such as the lid motor 30 and/or the lid piston 32, at a deliberate and safe rate of speed. The operator will have the ability to stop the lid via an emergency stop option, optionally in the form of a button on the display 72, in the event of a visual obstruction or other problems that they might notice during this part of the process.

In one embodiment, the lid 14 raises from the front, upward, and back completing at a 90-degree angle with respect to the tank 12. The shape and dimensions of the lid 14 allow the machine 1 to be placed closer to the wall behind it, allowing less space to be utilized for that purpose. Once the lid 14 is raised, the operator will be asked if they are ready to have the basket 18 raised. Once acknowledged, possibly on the display 72, the basket 18 will begin to raise automatically by way of one or more mechanical actuators, such as the basket motor 24 and/or at the basket piston 26.

Optionally, the operator will have the ability to stop the basket 18 from rising via the same or a different emergency stop option, in the form of a button on the display 72, in the event of a visual obstruction or other problems that they might notice during this part of the process.

Optionally, once the corpse 39 is place or slid into the raised basket 18, the process of lowering the basket 18 and/or the lid 14 is similar or reverse to that described above.

In one embodiment, the unique shape of the basket 18 and the way the corpse 39 is loaded into the machine 1 is important and unique in the sense that as the basket 18 slowly, deliberately, and safely lowers, the corpse 39 will gently slide down the side of the basket 18 toward a bottom of the basket 18. When the basket 18 has fully returned to its resting position, the body 39 should be at the lowest point of the basket 18 and the tank 12. Ideally, the body 39 will have slid down to be in a supine position at the lowest point of the basket 18. This position is simply a desire of the machine designers to imitate how a body is laid out traditionally in a casket and the reverence that goes with those images, however, it is not required that the corpse 39 be in a supine position. Any position the corpse 39 ends-up in at the lowest part of the basket 18 will not affect in any way how the machine 1 and the optional process described herein perform the intended purpose. The same result will be achieved in any position, but the operator would have the ability to manipulate the corpse 39 to whatever position they would prefer.

The uniqueness of the machine 1 of the presently disclosed technology allows for representatives of the decedent to witness the insertion of the remains into the machine 1 in a way that is purposeful, respectful, and dignified through what is considered normal in the funeral industry.

Optionally, once the basket 18 is completely lowered to the resting position (e.g., see FIGS. 5 and 6), the display 72 will ask if the operator is satisfied with the starting position of the corpse 39. Once the operator acknowledges affirmatively, the basket 18 and/or the machine 1 will automatically weigh the corpse 39 and provide this information to the operator via the display 72. The display 72 will also provide the operator with the correct amount of chemical material that needs to be added to the machine 1 to complete the process of decomposing the corpse 39. Optionally, the operator will then manually place the appropriate amount of chemical material into the tank 12 and/or the machine 1. Alternatively, the appropriate amount of chemical material can be automatically added to the tank 12 and/or the machine 1.

In one embodiment, the chemical material or composition has been specially formulated to optimize the use of the machine 1 and to lower the time it takes to complete a cycle. The specially formulated chemical materials will be in premixed units that are easy to store and handle. The number of premixed units that is added to the machine 1 is based on the weight of the corpse 39 that is being processed.

An example of the above is as follows. If the corpse 39 being processed weighs 100 lbs, and the solution requires 15% of the weight of the corpse 39 being the amount of Potassium Hydroxide (KOH) required, then 15lbs of KOH is entered into the tank 12 and/or the machine 1. Optionally, the premixed design would also have other premixed chemicals included, attached, and/or associated to the KOH. If each premixed chemical “block” or “unit” contains 5 lbs of KOH, then the display 72 of the cabinet 70 would instruct the operator to manually place three blocks into the tank 12 and/or the machine 1. The premixed chemicals would be in a form that is safer and accurately measured to add more safety to the operator.

The prior art method requires the operator to measure the chemicals on an individual basis and to manually place the loose KOH into the tank 12 and/or the machine 1, which allows for particles of this caustic material to be floating around the area of insertion, which adds an unneeded level of hazardous material exposure to the operator. The packaging of the chemical design of the presently disclosed technology will not allow this and will be required for use within the machine design.

In one optional embodiment, the operator may be required to acknowledge on the display 72 that they have complied with the instructions and that the correct number of blocks has been added into the machine. Once the chemical is in place, the display 72 optionally will ask the operator to confirm and then ask if they are ready for the lid 14 to be closed. Once acknowledged, the lid 14 will begin to slowly lower to the original and resting closed position (see, e.g., FIGS. 5 and 6). The operator will have the ability to stop the lid 14 from lowering via the same or an additional emergency stop option, optionally in the form of a button on the display 72, in the event of a visual obstruction or other problems that they might notice during this part of the process.

In one embodiment, once the lid 14 is completely closed (e.g., see FIGS. 1, 2, and 4), a lever or other actuator must be manually manipulated by the operator and the display will instruct the operator to do so. The lever is manipulated to ensure the lid 14 is closed snug tight so that a seal around the lid 14 is completely sealed, which optionally adds another and redundant level of protection that the lid 14 does not inadvertently become opened. Opening the lid 14 during the cycle is a very unlikely possibility as it utilizes an automatic actuator that opens and closes the lid through the software installed. Optionally, the machine 1 can be programmed to hold the lid 14 closed tight until the completion of the decomposition process. A sensor will read and/or recognize that the lever is in place and the display 72 will redundantly ask the operator if the lever is in place.

In one optional embodiment, once the operator confirms that the lever is in place, the display 72 will ask the operator if they are ready to begin the decomposition process. Once the operator confirms that the decomposition process is ready to begin, the machine 1 will begin the process and at this point the machine 1 becomes fully automated with no more input needed from the operator until the completion of the process.

Optionally, cold or “tap” water will begin to enter the side unit of the cabinet 70 through an inlet pipe 74. In one embodiment, the water will be directed to a water heater 76, such as a tankless electric water heater, installed inside the cabinet 70. Optionally, prior to reaching the water tank 76, the inlet water can pass through a dispersement modulator 94, which can be operatively and/or fluidly connected to several components of the cabinet 70. The purpose of the water heater 76 is to preheat the water prior to entering the tank 12 where the remains 39 and the chemicals are waiting to be processed. The water heater 76 will preheat the water, optionally to a temperature between 120- and 130-degrees Fahrenheit or higher (e.g., a 1.5 gallons/minute). This water will flow directly from the water heater 76, through the side of the cabinet, into the side of the tank 12, and begins to fill the tank 12 with already partially heated water.

No prior art machine exists for the intended purpose of pre-heating the water as part of the normal process internally. The possibility of connecting to an external hot water heater is not desirable, as doing so requires more space, and costs more money to the consumer in extra pieces needed or wanted to accomplish this. Operators do not want the hassle or do not have the space for an external water heater and so the water in prior art machines enters their systems at tap water temperature. The consumers want the ability though, and so an optional embodiment of the presently disclosed design simply comes standard with this already built in allowing for ease of use.

In one embodiment, pre-heated water is preferred because the process of dissolving a corpse 39 can happen at any water temperature using KOH. The colder the water is, though, the longer the process takes to complete. Water from the tap is approximately 55-60 degrees Fahrenheit on average. It can be closer to 45 degrees Fahrenheit in much more harsh climates.

When water exits the water heater 76 and enters the tank 12 between 120 and 130 degrees, the operator is saving the time, which can be significant, in raising the temperature in the tank 85 degrees from 45 to 130 degrees, or in a less extreme and more likely conditions, raising the temperature 75 degrees to achieve the starting point of 130 degrees from 55 degrees. Those ranges of raising the water temperature to achieve what is already the starting point of the present uniquely designed machines of 130 degrees can take hours.

In prior art processes this adds significant time, which is a severe reduction in efficiency of the process for the operator. The increase in the process time of the prior art also adds to the cost to operate the machine as the use of electricity needed to be utilized for a longer period of time to complete an entire cycle.

In one embodiment, the pre-heated water will start filling the tank 12 from the cabinet 70. Because the water is preheated, as soon as the water contacts the chemicals, it will begin to activate the chemicals immediately and the process of breaking down the proteins, or tissue, of the corpse 39 (e.g., a domesticated pet or the yield of a hunt, such as deer) begins at an efficient rate within minutes of starting the machine 1.

In one optional embodiment, the tank 12 includes one or more ports 16, which can be in the form of side jet tubes shown in FIGS. 1, 3, 4, and 6-9. Optionally, the machine 1 can include three or four spaced-apart ports 16 on each side (e.g., back and front, or lateral sides). The ports 16 allow the liquid to be recirculated into and/or out of the tank. Optionally, each port 16 will be aimed toward the corpse 39 within the basket 18. In one embodiment, a sensor will activate one or more pumps 16 to circulate the water within the tank 12 to begin the agitation of the water.

In one optional embodiment, as the water level rises to just above one or more heating elements 36 (shown schematically in FIG. 5) located in or at the bottom of the tank 12, at least one sensor will be tripped which will automatically engage the software to turn the heating element(s) 36 on. The energy and time needed to heat a low volume of water that is beginning at 120 to 130 degrees Fahrenheit is minimal and the heating that takes place within the tank will begin immediately as soon as the sensor is tripped. By the tank 12 immediately beginning to heat the pre-heated water, and with the chemicals being activated immediately, this causes the process of breaking down the remains to begin immediately, even before the full amount of water that is required in the tank 12 is in place, which is far more efficient and takes less time to complete a full cycle.

Optionally, the water level will continue to rise and/or fill-up the tank 12 and will trip or activate another sensor that indicates the water level has at that point raised to be above the ports that allow for the water to be circulated back into the tank.

In one embodiment, having multiple, spaced-apart ports 16 to agitate or be the end point in circulation of the water is important as it will assist in breaking down the remains at a faster pace, again, causing the process to be more efficient and take less time to complete. The machine 1 of the presently disclosed technology optionally has multiple ports that are specifically designed to make multiple points of directed, positively pumped water at the corpse 39. In a sense, these points of directed water will help to remove, or dislodge, larger pieces of flesh that then can be broken down more quickly. When more “pieces” of the corpse 39 are released into the solution, this creates more surface area that is exposed to the solution which allows a quicker, more efficient process to take place and a shorter cycle overall.

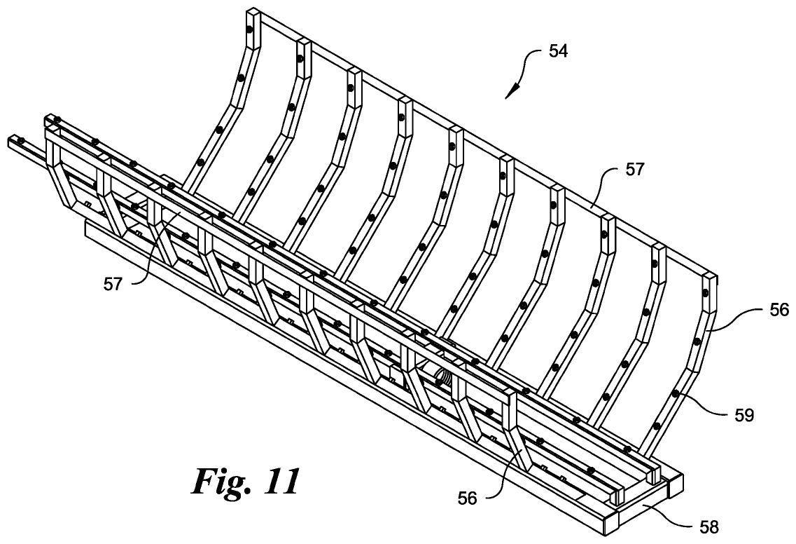

Alternatively, or additionally, as shown in FIG. 11, the machine 1 can include a header assembly, generally designated 54, configured to ease and expedite the decomposition process within the tank 12. Optionally, the header assembly 54 can be located within the tank 12 and between the tank 12 and the basket 18. The header assembly 54 can be fluidly connected to the cabinet 70. The header assembly 54 can be sized, shaped, and or configured to permit the above described movement of the basket 18 with respect to the tank 12. Optionally, the header assembly 54 is fixedly secured inside the tank 12 and operatively connected and/or in fluid communication with the cabinet 70.

The header assembly 54 can be configured to increase the surface area of the corpse 39 that is subjected to moving water and/or water/chemical mixture, which in turn expedites the decomposition process and increases both the mechanical and chemical breakdown of the corpse 39. In particular, in one optional embodiment, the header assembly 54 can include a plurality of spaced-apart arms 56 that extend outwardly in an accurate manner from a base portion 58. A shaft 57 can be secured to an upper end of each arm 56 on one side of the base portion 58. A plurality of openings or jets 59 are located throughout the header 54 to help increase the surface area of the corpse 39 that is subjected to the moving water and/or chemical combination. Water and/or the chemical combination essentially cut into the corpse 39 as a result of the jets 59. Each jet 59 can be enlarged or reduced in size to create less or more force on the corpse 39.

In one optional embodiment, the machine 1 of the presently disclosed technology allows for many different pumps to be utilized in the process and through this machine. One type of pump that can be used in the machine is a peristaltic pump. No prior art machines that are used for this purpose utilize a peristaltic pump. Another type of pump that can be used is a boiler pump, a lobe pump, a rotary lobe pump, a stainless steel lobe pump, a diaphragm pump, a sliding shoe pump, and the like.

An advantage of using a peristaltic pump is that at no point does the caustic fluid encounter any mechanical part of the pump, specifically the metal parts of the pumps that are out there on the market. The high alkalinity level is corrosive to most metallic materials. A standard pump does not hold up to the corrosive fluid. When a standard pump fails, it tends to leak out of the unit, which would cause dangerous and biohazardous materials exposure. Peristaltic pumps, for example, utilize tubing and rolling motion to create back pressure that becomes the positive fluid flow. The caustic fluid only ever encounters the inner portion of the specially designed and purpose manufactured tubing used for the fluid to flow through. This far increases the longevity of the pump, and the maintenance of the pump only involves swapping out the tubing periodically. If such a pump eventually fails, there is no mechanical part that would leak dangerous and biohazardous materials. It would stay contained in the tubing. The shut off valves that are before and after the pump would contain everything within the unit until it could be properly disposed of. Also, the rate of flow on a peristaltic can be easily adjusted whereas a conventional pump is not as simple. There are other pumps that are considered great for this purpose as well, including an all-stainless steel Rotary Lobe Pump, and many more. The unique modular aspect of the machine 1 of the presently disclosed design covers many parts of the machine 1, including the pump(s).

In one optional embodiment, the water will continue to rise until it reaches the sensor that will tell the machine 1 and/or cabinet 70 to stop adding water from the water tank 76. At this point in the process, the heating element(s) 36 within the tank 12 will continue to raise the temperature of the water until the desired temperature is achieved. All the while the remains of the corpse 39 are simultaneously being processed. A sensor will tell the machine 1 when to turn off the heating element(s) 36 to not heat the water to above the appropriate temperature.

The machine 1 of the presently disclosed technology is optionally designed to heat the water to just above the temperature of boiling. Higher temperature, with the correct chemical mixture, and the agitation of the fluid in the way the machine is designed, all contribute to the process taking less time, and being more efficient energy and otherwise.

Boiling is a relative temperature based on the elevation at which one is located. For example, the boiling point of water at sea level is 212 degrees Fahrenheit. In contrast, Denver, Colorado sits at an elevation of 5,280 feet, and the boiling point of water there is 203 degrees Fahrenheit. The software of the presently disclosed technology allows the operator, for example, to set the elevation at which the machine 1 will operate during the initial install and set up, and the software will automatically make the adjustments requiring no additional input from the operator.

Optionally, the heating element(s) 36 within the tank 12 will be automatically controlled based on constant sensor readings being taken and fed into the control unit 72 or a motherboard 80 (e.g., see FIG. 10). Numerous other components of the cabinet 70 and/or the machine 1 can be operatively connected to the motherboard 80. For example, the motherboard can be electrically connected to the basket motor(s) 24 and/or the lid motor(s) 30 to selectively control the operation thereof, and/or a speaker or noise module 84 to audibly communicate with the operator. In one embodiment, the heating element(s) 36 will automatically turn on at a preset low temperature based on elevation of the machine 1 and bring the heat of the water within the tank 12 back up to optimal operating temperature. Optionally, the heating element(s) 36 can be turning on and off, automatically controlled by the cabinet 70, to maintain the optimal temperature.

In one embodiment, the exterior of the tank 12 will be insulated using a urethane foam. The lid 14 can be insulated in that way, but can also be insulated between layers of stainless steel. This will allow for the machine 1 to maintain optimal operating temperature with general ease. Optionally, the exterior of the machine 1, around the modular supporting legs 42, can be covered with sheet metal that adds protection to the operator by not allowing the operator to access the area beneath the tank 12. The exterior of the machine 1 that is accessible to the operator never reaches a temperature that is harmful to the touch.

Boiling allows for water vapor to be created, which if allowed to exit the tank 12 would mean that the water level within the tank would drop over the course of time. If the vapor is restricted from leaving the tank 12, then pressure would build up and possibly become a safety issue. The unique design of the machine 1 of one embodiment of the presently disclosed technology allows for both to occur. Optionally, the machine 1 is purposely designed to allow the water vapor created from the slightly boiling water to accumulate and condensate on the underside or interior of the lid 14, which can be designed with a slight angle that allows the condensation to roll forward and down, recycling itself back into the water of the tank 12. This allows for optimal use of water resources and for less water waste during the process.

It is possible that there could be a buildup of pressure that takes place within the tank 12. In one embodiment, at least one vent 53 (see FIGS. 2 and 10) is designed into the machine 1 and/or the tank 12 that can be regulated via a valve 91, such as a mechanical check valve, that automatically opens by the back pressure created. It will automatically release the pressure needed to regulate the pressure on the inside of the machine 1 and/or the tank 12 to not create a pressured and dangerous vessel. The vapor that is released from the machine 1 and/or the tank 12, through the valve 91, will then enter a line or pipe 93 (see FIG. 10) with a downward slope. This line 93 will connect from the valve 91 and terminate in a portion of the cabinet 70, directly connecting to the drain line of the machine 1 and/or the tank 12. This line 93 will not be insulated, and the natural cooling of the line 93 will allow the vapor to condensate back to liquid and be safely disposed of in the drain. In one embodiment, the operator will not have access to touch or manipulate this line.

At some point during the process in one embodiment of the presently disclosed technology, enough vapor will have escaped, and a water level sensor will trigger the water heater 76 to inject more pre-heated water into the tank 12, which will self-regulate to keep the optimal water level. No prior art machine utilizes this type of vapor regulation in the process. Every prior art machine requires the vapor to be vented outside through a wall or through a ceiling to open air, which severely limits where those machines on the market can be installed.

Optionally, none of the above-described operation of the presently disclosed technology requires any input from the operator and is all automated by the machine's software controls. By draining the vapor that condensates after the check valve 91 directly into the drain line 93 allows for the machine 1 to be placed in many different areas of a building and requires no retrofitting or alterations of the space in which the machine 1 will be operated, the only exception being the need for water supply, drain supply, and electricity. All of which are at a severely lower cost to the operator to install versus retrofitting an entire area.

In one embodiment, this process and cycle will continue like this until all of the remains have been dissolved. The time it takes to dissolve the remains will be based on the weight information and/or the amount of chemical that was required to be added to the machine 1 at the beginning of the process. Optionally, this will be an automated timed process.

In one embodiment, once the software has decided the appropriate amount of time to run the cycle, a chemical will be used to neutralize the alkalinity of the fluid. The prior art standard of the machines available are to release the solution from the machine, at full alkalinity and temperature into the sewer system or whatever vessel for the disposal that is required for their area. This is not environmentally beneficial or desirable.

There are currently no Environmental Protection Agency (EPA) or Department of Environmental Protection (DEP) requirements placed on the alkaline hydrolysis process, as the emissions are not harmful and nothing is released into the environment. The prior art alkaline hydrolysis process takes place at an alkalinity level of PH 12 and above. This can potentially be a problematic level, and the temperature can potentially be problematic to simply drop down the drain.

In contrast, at or near the end of the cycle, within the machine 1 of one optional embodiment of the presently disclosed technology, an acid will optionally be introduced by automation into the fluid to neutralize the solution down to a safe level, such as at or around PH 7. PH 7 is the PH level of standard water. The process of alkaline hydrolysis kills and neutralizes any harmful or biohazard portions of the remains during the cycle, the presently disclosed automated process then neutralizes, via an acid, the solution in the tank 12. This means that the solution is no longer a biohazard and is no longer dangerous being at an extreme alkalinity. After neutralization, the solution is safe. But it will still not be accessible to the operator.

Optionally, the acid can be delivered in either a solid or liquid form, depending on the preference of the consumer. Whether they choose liquid or solid, optionally the delivery system will be automated and at no time is the operator exposed to the neutralization solution during the cycle.

In one embodiment, at this point in the cycle, with the liquid being safely neutralized, the temperature will still be relatively high and potentially dangerous. Although the liquid can be put through the drain and into the sewage system at a boiling or just below temperature, much the same way people do when draining the boiling water into their sink after boiling spaghetti noodles, it is not the best option. The extreme temperature can have negative effects on the drainage system of the building in which the process is taking place. An example of this would be that Schedule 40, PVC pipe, of which most drainage systems in buildings in the United States are made up of, have a maximum operating temperature of 140 degrees Fahrenheit. Meaning, when fluid at that temperature or above passes through it, it can begin to sag and erode the integrity of the pipe. No prior art machine intentionally, as part of the normal process, cools the solution as it exits the system. The machine 1 of one embodiment of the presently disclosed technology is designed to purposefully cool the effluent before entering the drainage system.

Optionally, the draining of the tank 12 will be done or assisted by gravity with a check valve 95 that is automatically opened at the end of a decomposition cycle. As the liquid solution exits the tank 12, it will optionally enter a mixing valve 96 that is located within the cabinet 70. The mixing valve 96 can be connected by a pipe to the dispersement modulator 94 with a back flow valve or preventer 90 therebetween. The cabinet 70 can utilize two or more flow valves 90 throughout the piping to control fluid flow to and from the tank 12.

The mixing valve 96 will mix cold tap water with the hot post cycle solution that will cool the solution to between 110 and 125 degrees Fahrenheit before it exits the cabinet 70, such as at exit port 86, and enters the existing drainage system of wherever the machine 1 is located. The process of neutralizing that solution and cooling the solution before it exits the cabinet 70 will allow the machine 1 to be used in any municipality without causing harm to any sewer infrastructure or throwing off the calculations at a water treatment plant by consistently sending high alkalinity solutions to them.

In one embodiment, when the draining water level reaches a certain low point that will be dictated by a sensor, a rinse cycle will commence. Optionally, hot water will be sent from the water tank 76 in the cabinet 70 to a line (optionally pipe 97 and/or pipe 93) that connects to a portion of the machine 1, such as the lid 14. A rinse cycle modulator 92 can operatively connect pipe 97 and pipe 93, as well as a pipe leading to the dispersement modulator 94.

In one embodiment, attached to or integral with the inside of the lid 14 is a bar type device or bar type rinse that can include a plurality of spaced-apart holes in it to allow for pressure to be built-up and for hot water or liquid to be sprayed through the holes at high pressure so that the hot water or liquid hits all or most areas of the interior of the machine 1 and/or the tank 12.

In one embodiment, a hot water rinse is important to the process. During the alkaline hydrolysis process, a film containing one or many oils and fats are released from the remains of the corpse 39 and can accumulate around the edges of the basket 18, the tank 12, and/or the machine 1. There can also be a coating of this film left on the bones of the corpse 39 that are captured in the basket 18. Higher pressure hot water rinse does not necessarily dissolve those oils or fats, but can be sufficient to keep the oil(s) and/or fat(s) in a liquid form and allow them to be rinsed down with the effluent solution once the tank 12 is empty. In one embodiment, a hot water valve will open to start filling the tank 12 again except this time the point is to fill the tank 12 enough to simply run the recirculating pump 78, rinse out the port supply lines and the pump 78 itself, and again rinse with the tube 93 on the lid 14 and allow to drain via gravity.

Optionally, a cold-water rinse will then occur with a similar process as the hot water rinse. The purpose of the cold-water rinse is to simply cool down the interior of the machine 1 and allow for anything that may have been missed in the hot rinses.

In one optional embodiment, cooling down the machine 1 with a cold-water rinse last can be important and is part of the process for a few reasons beginning with it will alleviate the possibility of opening the machine 1 and being exposed to hot metals. It will also alleviate the escape of water vapor and evaporating hot water into the room when the lid 14 is opened.

In one optional embodiment, at the end of the cycle the display 72 will tell the operator that the cycle is complete and will require the operator to acknowledge that fact. The operator will then be instructed to release the handle that held the lid 14 firmly shut and will require the operator to acknowledge when completed. The display 72 will ask the operator if they want to have the lid 14 opened and will require the operator to acknowledge this. Then the operator will be asked if they want to raise the basket 18 and will require the operator to acknowledge that.

All those same processes will give the operator the option to stop that part of the process via an emergency stop option, such as in the form of a digital button on the display screen 72 in the event of a visual obstruction or other problems that the operator might notice during this part of the process. In an embodiment when the basket 18 raises, what will be left are the bones of the remains from the corpse 39 that was processed through the machine 1. The operator will then be able to collect the remains to have them processed through the next steps of the total process, not involving the machine 1 itself.

The display 72 will, optionally, remind the operator to remove all remains and ask the operator to acknowledge when that is finished, they will then be asked to acknowledge if the entire process has been completed. Upon responding in the affirmative via the display 72, the basket 18 will lower, the lid 14 will lower to be almost completely closed, and the machine 1 will then be at rest until the next use.

Optionally, all of the above processes will give the operator the option to stop that part of the process via an emergency stop option, optionally in the form of a digital button on the display 72, in the event of a visual obstruction or other problems that they might notice during this part of the process. In one embodiment, a slight gap is intended to be left open between one edge of the lid 14 and one edge of the tank 12 at the completion of a cycle so that the machine 1 has the chance to be aired out and air dried, or the operator may immediately begin the process again with another set of remains or another corpse 39.

In one embodiment, the cabinet 30 can include, house, and/or contain a converter. Optionally, the converter is a three-phase converter. A digital phase converter can be configured to create a three-phase power supply from a single-phase supply. The converter can be a rotary phase converter that uses or includes an induction generator motor, which can be configured to rotate to transform single-phase utility power into three-phase electricity.

FIG. 10 shows a gap or spacing between the cabinet 70 and the tank 12. This gap or spacing can be increased or decreased, depending upon the needs of the operator, the space available for the machine 1, or the length of piping available. Although the display 72 is schematically depicted as a computer monitor 72, in one optional embodiment the display 72 can be built into and extend parallel to the exterior surface of the cabinet 70. In another optional embodiment, the display 72 can be omitted, for example if the user's separate computer or mobile smart phone is configured to interact and instruct the motherboard through an application.

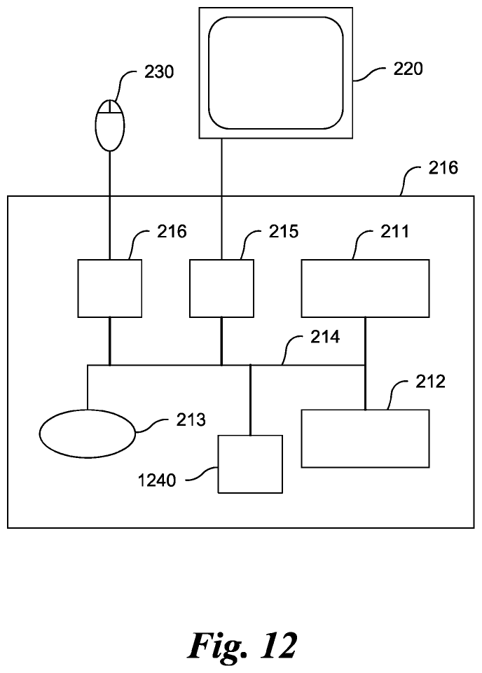

One or more of the above-described techniques and/or embodiments can be implemented with or involve software, for example modules executed on one or more computing devices 210 (see FIG. 12). Of course, modules described herein illustrate various functionalities and do not limit the structure or functionality of any embodiments. Rather, the functionality of various modules may be divided differently and performed by more or fewer modules according to various design considerations.

Each computing device 210 may include one or more processing devices 211 designed to process instructions, for example computer readable instructions (i.e., code), stored in a non-transient manner on one or more storage devices 213. By processing instructions, the processing device(s) 211 may perform one or more of the steps and/or functions disclosed herein. Each processing device may be real or virtual. In a multi-processing system, multiple processing units may execute computer-executable instructions to increase processing power.

The storage device(s) 213 may be any type of non-transitory storage device (e.g., an optical storage device, a magnetic storage device, a solid-state storage device, etc.). The storage device(s) 213 may be removable or non-removable, and may include magnetic disks, magneto-optical disks, magnetic tapes or cassettes, CD-ROMs, CD-RWs, DVDs, BDs, SSDs, or any other medium, which can be used to store information. Alternatively, instructions may be stored in one or more remote storage devices, for example storage devices accessed over a network or the internet.

Each computing device 210 additionally may have memory 212, one or more input controllers 216, one or more output controllers 215, and/or one or more communication connections 1240. The memory 212 may be volatile memory (e.g., registers, cache, RAM, etc.), non-volatile memory (e.g., ROM, EEPROM, flash memory, etc.), or some combination thereof. In at least one embodiment, the memory 212 may store software implementing described techniques.

An interconnection mechanism 214, such as a bus, controller or network, may operatively couple components of the computing device 210, including the processor(s) 211, the memory 212, the storage device(s) 213, the input controller(s) 216, the output controller(s) 215, the communication connection(s) 1240, and any other devices (e.g., network controllers, sound controllers, etc.). The output controller(s) 215 may be operatively coupled (e.g., via a wired or wireless connection) to one or more output devices 220 (e.g., a monitor, a television, a mobile device screen, a touch-display, a printer, a speaker, etc.) in such a fashion that the output controller(s) 215 can transform the display on the output device 220 (e.g., in response to modules executed). The input controller(s) 216 may be operatively coupled (e.g., via a wired or wireless connection) to one or more input devices 230 (e.g., a mouse, a keyboard, a touch-pad, a scroll-ball, a touch-display, a pen, a game controller, a voice input device, a scanning device, a digital camera, etc.) in such a fashion that input can be received from a user.

The communication connection(s) 1240 may enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

FIG. 12 illustrates the computing device 210, the output device 220, and the input device 230 as separate devices for ease of identification only. However, the computing device 210, the output device(s) 220, and/or the input device(s) 230 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). The computing device 210 may be one or more servers, for example a farm of networked servers, a clustered server environment, or a cloud service running on remote computing devices.

The following exemplary embodiments further describe optional aspects of the presently disclosed technology and are part of this Detailed Description. These exemplary embodiments are set forth in a format substantially akin to claims (each with numerical designations followed by a letter), although they are not technically claims of the present application. The following exemplary embodiments refer to each other in dependent relationships as “embodiments” instead of “claims.”

1A. A machine configured to perform alkaline hydrolysis, the machine comprising:
a body having a base wall and a sidewall extending upwardly therefrom, the body defining a cavity configured to receive liquid and a body of a human being;
a lid pivotally attached to the body about at least one hinge, the at least one hinge being attached to the lid and the sidewall of the body, the lid being pivotable with respect to the body between a closed position and an open position; and
a basket movable into and at least partially out of the body when the lid is in the open position.

2A. The machine of embodiment 1A, wherein the basket is pivotable with respect to the body.

3A. The machine of embodiment 2A, wherein a piston is configured to rotate the basket into and at least partially out of the body.

4A. The machine of any one of embodiments 1A-3A, wherein the basket includes an arcuate bottom.

5A. The machine of any one of embodiments 1A-4A, wherein at least a portion of the basket is porous.

6A. The machine of any one of embodiments 1A-5A, wherein the basket is configured to receive the human body.

1B. A method of performing alkaline hydrolysis on a corpse, the method comprising:
loading a corpse into a basket of a machine configured to perform alkaline hydrolysis;
causing the basket to rotate with respect to a body of the machine so that the basket and the corpse are positioned entirely within the body.

2B. The method of embodiment 1B, further comprising:
rotating a lid of the machine to a closed position so as to enclose the basket and the corpse within the machine.

3B. The method of embodiment 1B or 2B, wherein prior loading the corpse into the basket, the corpse is transported on a rolling bed to a side of the body of the machine.

1C. A machine configured to perform alkaline hydrolysis, the machine comprising:
a body defining a cavity configured to receive liquid and a corpse;
a lid pivotally attached to the body about at least one hinge, the at least one hinge being attached to the lid and the body, the lid being pivotably with respect to the body between a closed position and an open position;
a basket configured to receive a corpse, the basket being positionable within the body; and
a support structure including a plurality of segments that are removably attachable to each other and the body, the support structure having an assembled configuration and a disassembled configuration, in the assembled configuration the support structure being configured to maintain the body, the lid, and the basket above a ground surface when in the assembled configuration.

1D. A method of preparing a corpse for alkaline hydrolysis, the method comprising:
receiving a lid prompt on a screen to open a lid of the machine;
acknowledging or accepting the lid prompt, thereby allowing the lid of the machine to pivot from a closed position to an open position with respect to a tank of the machine;
receiving a basket prompt on the screen to open or raise a basket from within the tank;
acknowledging or accepting the basket prompt, thereby allowing the basket to rise up at least partially out of the tank; and
moving a corpse at least partially into the basket.

While the presently disclosed technology has been described in detail and with reference to specific examples thereof, it will be apparent to one skilled in the art that various changes and modifications can be made therein without departing from the spirit and scope thereof. It is understood, therefore, that the presently disclosed technology is not limited to the particular embodiments disclosed, but it is intended to cover modifications within the spirit and scope of the presently disclosed technology as defined by the appended claims.

1. An alkaline hydrolysis machine comprising:
a tank defining a cavity configured to receive liquid containing alkaline chemicals;
a lid pivotally attached to the tank about at least one hinge, the at least one hinge being attached to the lid and the tank, the lid being pivotably with respect to the tank between a closed position and an open position;
a basket positionable within the tank when the lid is in the closed position, the basket being configured to receive a corpse and hold the corpse in a spaced-apart manner from an interior of the tank; and
a header assembly positioned within the tank beneath the basket, the header assembly being fixed with respect to the tank, the header assembly including a plurality of spaced-apart arms extending outwardly in an arcuate manner from a linear base portion, an end of each arm opposite the base portion being attached to a linear shaft, a plurality of spaced-apart openings are located throughout the header assembly and are configured to allow any of the liquid within the header assembly to pass therethrough to spray onto or into the basket.

2. The machine of claim 1, further comprising:
a cabinet positioned outside of and fluidly and operatively connected to the tank or the header assembly, the cabinet enclosing a water heater configured to preheat tap water prior to entering the tank and then delivering the heated tap water to the header assembly or inside of the tank.

3. The machine of claim 1, wherein the water heater heats the tap water to at least 120-degree Fahrenheit.

4. The machine of claim 2, wherein the cabinet includes a pump configured to move liquid into and out of the tank.

5. The machine of claim 4 wherein the cabinet includes a motherboard operatively connected to the pump, a display on the cabinet allows an operator to control the pump through the motherboard.

6. The machine of claim 1, further comprising:
a support structure including a plurality of segments that are removably attachable to each other, the support structure having an assembled configuration and a disassembled configuration, in the assembled configuration the support structure being configured to maintain the tank, the lid, and the basket above a ground surface.

7. The machine of claim 6, wherein the support structure is in the disassembled configuration when at least some of the plurality of segments are not attached to each other.

8. The machine of claim 6, wherein the machine is modular so that it can be disassembled, transported, and then reassembled.

9. The machine of claim 6, wherein the plurality of segments of the support structure include a plurality of upper legs, each upper leg including a leg coupler configured to removably attach to a lower leg.

10. The machine of claim 1, wherein the basket is pivotable with respect to the tank, the basket being configured to pivot upwardly away from the tank and downwardly into the tank.

11. The machine of claim 10, wherein a basket motor is operatively connected to a basket piston, which is operatively connected to a basket link, wherein operation of the basket motor moves the basket piston, which in turn moves the basket link to pivot, raise, and lower the basket with respect to the tank.

12. The machine of claim 10, wherein a lid motor is operatively connected to a lid piston, which is operatively connected to a lid link, wherein operation of the lid motor moves the lid piston, which in turn moves the lid link to pivot the lid with respect to the tank.

13. A method of preparing to alkaline hydrolysis on a corpse, the method comprising:
receiving a lid prompt on a screen to open a lid of a machine configured to hold a corpse;
acknowledging or accepting the lid prompt, thereby allowing the lid of the machine to pivot from a closed position to an open position with respect to a tank of the machine;
receiving a basket prompt on the screen to raise a basket from within the tank;
acknowledging or accepting the basket prompt, thereby allowing the basket to rise up at least partially out of the tank; and
moving a corpse at least partially into the basket.

14. The method of claim 13, further comprising:
engaging an emergency stop to halt movement of the lid or the basket.

15. The method of claim 13, further comprising:
receiving a satisfaction prompt on the screen regarding whether a position of the corpse within the basket or the tank is acceptable.

16. The method of claim 13, further comprising:
adding a prescribed amount of alkaline chemicals to the tank in accordance with instructions on the screen.

17. The method of claim 16, further comprising:
receiving a closure prompt on the screen to close the lid; and
acknowledging or accepting the closure prompt, thereby allowing the lid to move to a closed position with respect to the tank.

18. The method of claim 17, further comprising:
receiving a lock prompt on the screen to actuate a lever or other actuator; and
moving or engaging the lever or other actuator to ensure that the lid is in the closed position.

19. The method of claim 18, further comprising:
spraying a liquid onto the corpse in the basket.

20. The method of claim 17, further comprising:
pumping a liquid from a cabinet adjacent to the tank into the tank.
